(19) United States
(12) Patent Application Publication
(10) Pub. No.: US 2026/0158685 A1
(43) Pub. Date: Jun. 11, 2026

(54) Multifunctional opening tool

(71) Applicant: Yifan Wang, Shenzhen (CN)

(72) Inventor: Yifan Wang, Shenzhen (CN)

(21) Appl. No.: 18/972,756

(22) Filed: Dec. 6, 2024

(51) Int. Cl. B26B 11/00; B41K 1/00; B41K 1/22; B41K 1/52; B43M 7/00

(52) U.S. Cl. CPC B26B 11/00; B41K 1/003; B41K 1/22; B41K 1/52; B43M 7/002; B43M 7/007

(57) ABSTRACT

This application disclosed a multifunctional unsealing tool, comprising a shell; a cutting mechanism, which is arranged inside one end of the shell and is used to open envelopes and cartons; wherein the cutting mechanism comprises: a cutting assembly, which is fixedly arranged inside one end of the shell; a sliding assembly, which is arranged between the cutting assembly and the shell and can slide up and down along the cutting assembly, and is used to cooperate with the shell to protect the cutting assembly; the cutting assembly is fixedly arranged inside one end of the shell.

### FIELD OF THE APPLICATION

The application relates to the technical field of daily necessities, in particular to a multifunctional opening tool.

### BACKGROUND

Openers are widely used tools in daily life, commonly found in both factories and homes for tasks like opening boxes, letters, and express parcels. Traditionally, tools used for opening boxes include utility knives and scissors; however, there are no specialized tools specifically designed for this purpose. Utility knives are efficient and quick for opening boxes, but their sharp blades can lead to accidental injuries, posing a risk to personal safety during use.

Scissors are commonly used to open packages in daily life. While they are generally safer than utility knives, there are still safety hazards to consider. The blades of scissors are sharp, which can pose a risk if not handled properly. Additionally, when using scissors to open packages or cartons, the process can be inefficient due to awkward handling.

To address the aforementioned issues, patent No. CN201010618347.4 describes an opener that consists of a shell and a disassembly component, which can move independently of the shell during extension and retraction. The shell is designed in the shape of a rectangular. The disassembly component comprising at least one of two types: a conical disassembly component and a scimitar disassembly component, or a combination of both. The conical end of the conical disassembly component and the scimitar-shaped end of the scimitar disassembly component can be extended or retracted into the shell either separately or simultaneously. This design allows users to cut not only thin tapes but also bandages, thick cartons, and other materials, offering significant convenience while greatly enhancing safety and efficiency. However, this design has its drawbacks. When the device is in use, the user must push a button to extend the unpacking component from the shell. Once the button is released, the unpacking component retracts back into the shell. As a result, users need to maintain pressure on the button with their finger to prevent the unpacking component from retracting while in use. If the user needs to unpack multiple items, finger fatigue can occur, which becomes inconvenient. Furthermore, when cutting through tough materials like bandages or thick cartons, more force is required to keep the unpacking component extended, increasing the likelihood of finger

Therefore, a multifunctional opening tool is designed for the above problems.

### SUMMARY

The technical problem to be solved by the present application is to overcome the defects of the above-mentioned technology and provide a multifunctional opening tool.

To address the technical issues described above, the present application offers a multifunctional opening tool. This tool consists of a shell and a cutting mechanism, which is located at one end of the shell. The cutting mechanism is designed for opening envelopes and cartons.

The cutting mechanism comprising:
a cutting assembly, which is fixed inside one end of the shell;
a sliding assembly, which is arranged between the cutting assembly and the shell and can slide up and down along the cutting assembly to cooperate with the shell to protect the cutting assembly.

In an embodiment, the design comprising an end functional component and a bottom cover. The end functional component is positioned inside one end of the shell and is snap-connected to it. One end of this component, which is located within the shell, is connected to and works in conjunction with the roller stamp component. The bottom cover is placed on the exterior of the end functional component and is also snap-connected to the shell. Together, they function to protect the end functional component.

As an improvement, the end functional component is a roller seal component, which is arranged inside one end of the shell and is used to cooperate with the shell to hide the logistics information.

The roller stamp assembly comprising:
A roller frame, the roller frame is clamped with the shell, one end of the roller frame located in the shell is provided with a first sleeve, one end of the cutting assembly is arranged in the first sleeve to fix the cutting assembly;
The roller is arranged in the roller frame, and one end of the roller is rotatably connected to the roller frame;
The roller limiter is arranged in the roller frame, one end of the roller limiter is rotatably connected to the roller frame, and the other end of the roller limiter is connected to the roller;
The oil storage cotton core is fixedly connected to the outside of the roller;
The printing pad is arranged on the outside of the oil storage cotton core, and is used to cooperate with the oil storage cotton core to realize the hiding of logistics information.

In an embodiment, the end functional component is a name stamp component, and the name stamp component is arranged inside one end of the shell.

The name stamp assembly comprising:
A mounting frame, the mounting frame is snap-connected with the shell, one end of the mounting frame located in the shell is provided with a second sleeve, one end of the cutting assembly is arranged in the first sleeve to fix the cutting assembly, and the other end of the mounting frame is provided with a mounting groove;
A seal, the seal is arranged in the mounting groove;
An inner plate, the inner plate is provided with a round hole, the inner plate is provided with a sleeve at the round hole, the inner plate is arranged between the mounting frame and the sliding assembly in the shell, the inner plate is sleeved on the second sleeve through the round hole and the sleeve, and can move up and down along the second sleeve, the inner plate is provided with support rods at the four corners, the other end of the support rods extends from the outer sides of the four corners of the mounting frame, and the height is higher than the seal.

In an embodiment, the cutting assembly comprising:
a latch, which is arranged inside the shell, one end of which is connected and matched with the end functional assembly, and a slot is arranged inside the other end of the latch;
a blade, which is arranged in the slot and fixed by connecting the pin and the latch;
a blade fixing buckle, which is arranged outside the slot of the blade and is connected with the latch to fix the blade in cooperation with the latch.

In an embodiment, the slider assembly comprising:
a slider, which is arranged between the latch and the shell and can move up and down along the latch;
a spring, which is sleeved on the latch, the upper end of the spring abuts against the lower end of the slider, and the lower end of the spring abuts against one end of the end functional assembly.

In an embodiment, a top cover is provided at the upper end of the shell, which is clamped with the shell. The top cover is placed outside the slider assembly to cooperate with the shell to cover the cutting assembly. The slider and the top cover are both provided with a V-shaped opening at one end away from the shell, and the upper end of the blade is placed in the V-shaped opening.

The advantages of the present application compared with the prior art are:

1. The cutting assembly is fixed inside one end of the shell, while the sliding assembly is positioned between the cutting assembly and the shell. This sliding assembly is capable of moving up and down along the cutting assembly. When opening cartons, document bags, or express parcels, the sliding assembly makes contact with the object and presses against the shell. As a result, the sliding assembly retracts into the shell, allowing the cutting assembly to extend outward. This coordinated movement makes it easy to open the object. The sliding assembly can be pushed back with minimal effort, preventing strain on the user's hands.

2. The top cover 101 is placed outside the slider assembly, which can shield the cutting assembly to avoid accidental injury caused by the cutting assembly. Secondly, the slider 601 and the top cover 101 are both provided with a V-shaped opening 102 at one end away from the shell 100, and the upper end of the blade 503 is placed in the V-shaped opening 102. In this way, when opening envelopes and document bags, the envelopes and document bags can be directly inserted into the V-shaped opening 102. The V-shaped opening 102 of the top cover 101 will support the envelopes and document bags, limit the length of the blade 503 entering the envelopes and document bags, and prevent the blade 503 from cutting the documents, etc. Then, pull the opening tool to move, and the blade 503 will open the envelopes and documents along the edges of the envelopes and documents, which is more convenient.

3. One end of the shell 100 is equipped with a functional component. When using the roller seal component, the ink can be applied to cover the logistics information by rolling the stamp pad 306, effectively hiding the logistics details. In contrast, when the name seal component is utilized, the opening tool serves a sealing function, making it convenient for users.

4. The product structure of the present application is relatively simple, small in size, and very easy to carry.

### BRIEF DESCRIPTION OF THE DRAWINGS

The technology may be more completely understood in connection with the following drawings, in which:

FIG. 1 is a front view of the multifunctional opening tool, according to an embodiment 1;

FIG. 2 is a perspective view of the multifunctional opening tool, according to an embodiment 1;

FIG. 3 is an exploded view of the multifunctional opening tool, according to an embodiment 1;

FIG. 4 is a cross-sectional view of the A-A section in FIG. 1, according to an embodiment 1;

FIG. 5 is a front view of the multifunctional opening tool, according to an embodiment 2;

FIG. 6 is a perspective view of the multifunctional opening tool, according to an embodiment 2;

FIG. 7 is an exploded view of the multifunctional opening tool, according to an embodiment 2;

FIG. 8 is a cross-sectional view of the A-A section in FIG. 5, according to an embodiment 2.

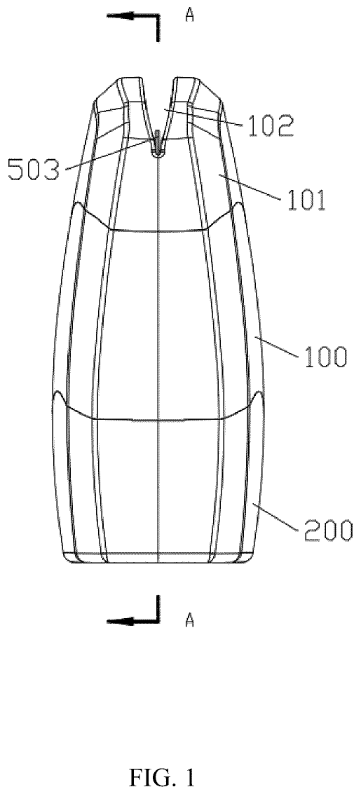

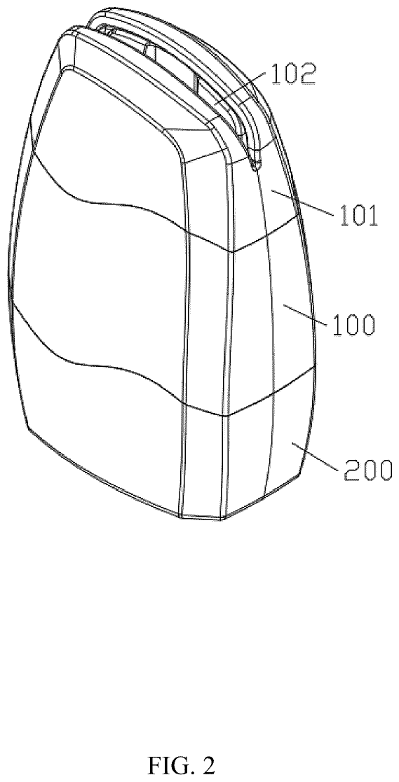

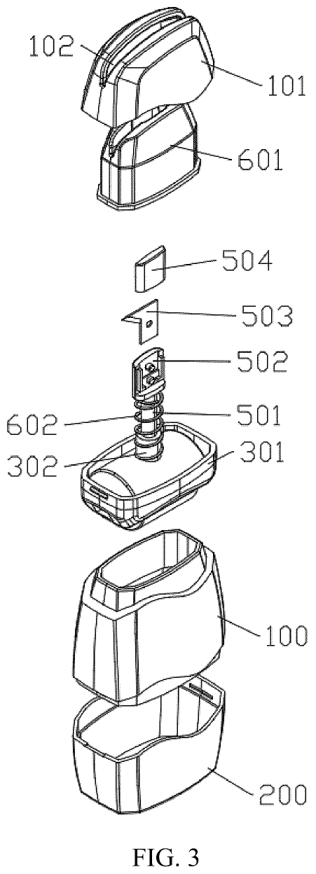

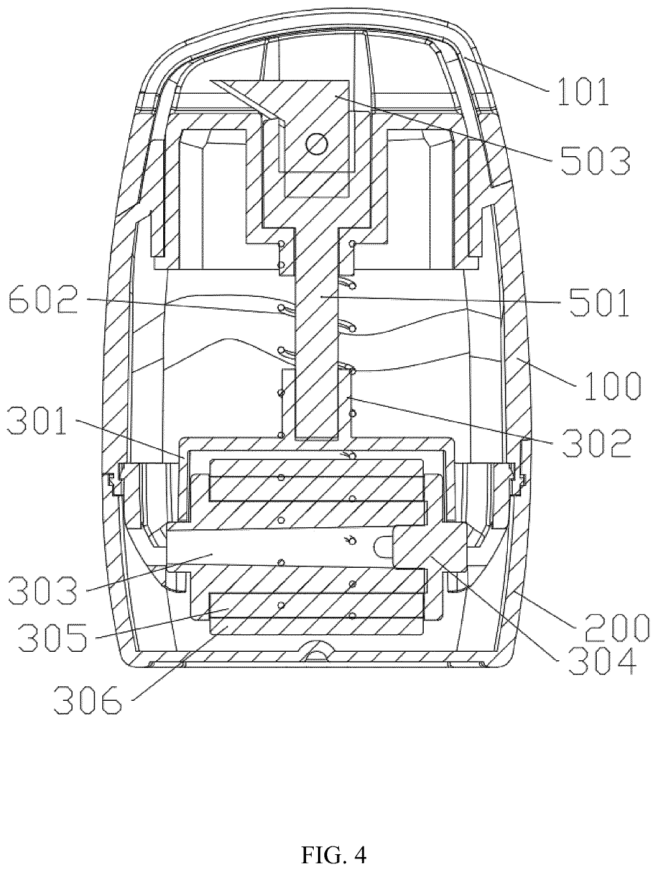

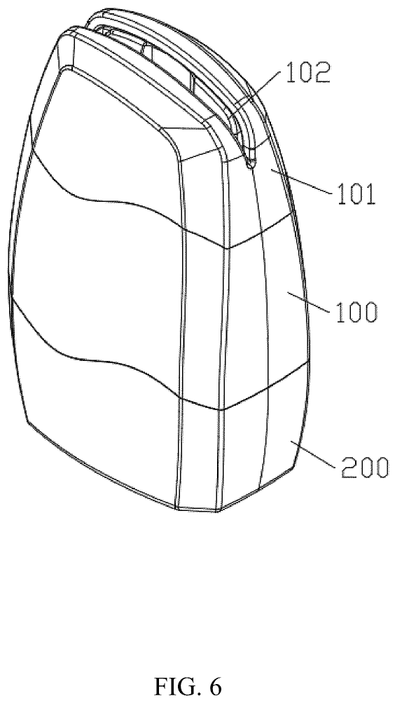

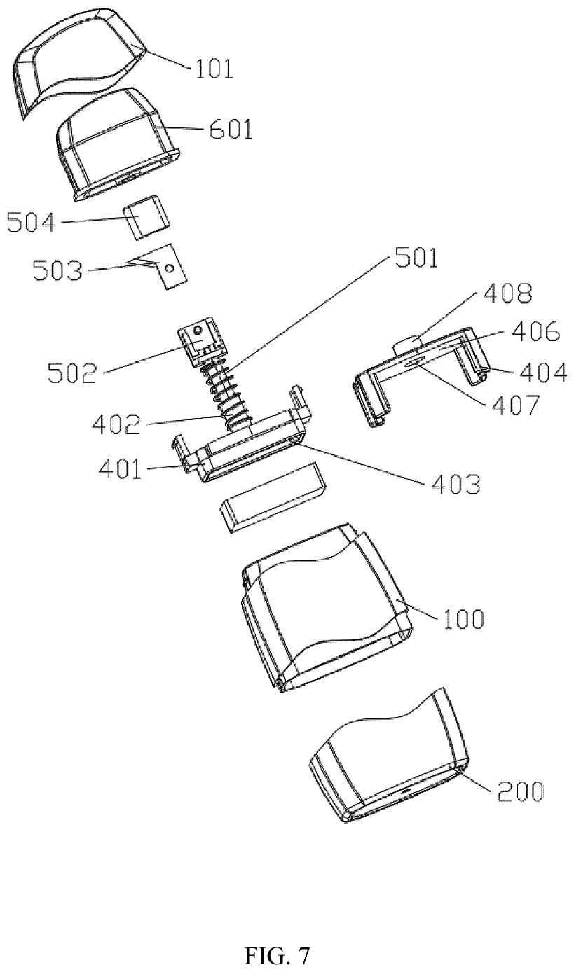

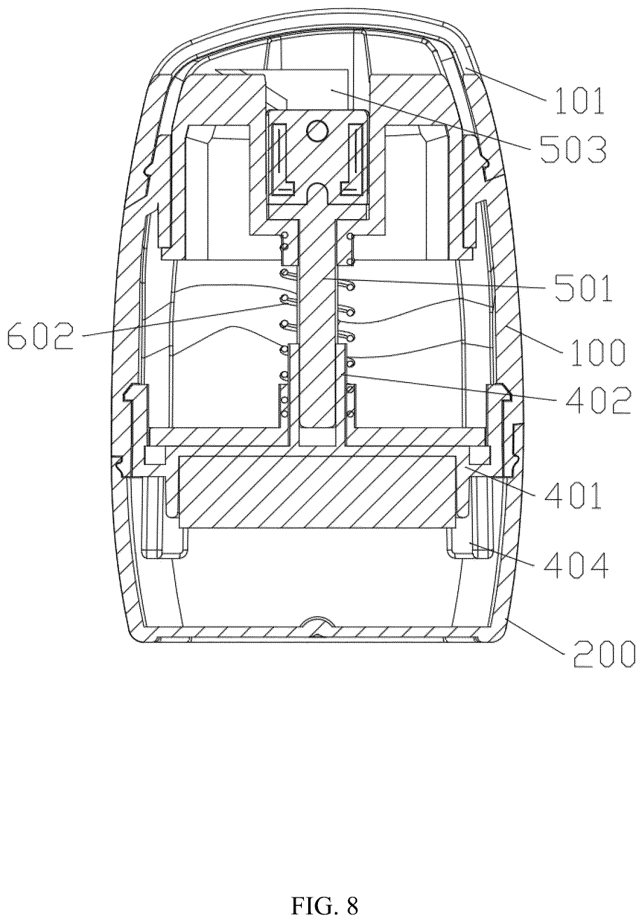

As shown in FIGS. 1-8:
100. shell
101. top cover,
102. V-shaped opening,
200. bottom cover,
301. roller frame,
302. first sleeve,
303. roller,
304. roller stopper,
305. oil storage cotton core,
306. stamp pad,
401. mounting frame,
402. second sleeve,
403. mounting groove,
404. support rod,
405. stamp,
406. inner plate,
407. round hole,
408. sleeve,
501. latch,
502. slot,
503. blade,
504. blade fixing buckle,
601. slider,
602. spring

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

As shown in FIGS. 1-8, a multifunctional opening tool comprising a shell 100; a cutting mechanism, the cutting mechanism is arranged inside one end of the shell 100, and is used to open envelopes and cartons;

The cutting mechanism comprising:
a cutting assembly, which is fixed inside one end of the shell 100 and is used to open envelopes, express parcels and cartons;
A sliding assembly, which is arranged between the cutting assembly and the shell 100 and can slide up and down along the cutting assembly, and is used to cooperate with the shell 100 to protect the cutting assembly.

Specifically, it also comprising an end functional component and a bottom cover 200, wherein the end functional component is arranged inside the other end of the shell 100 and is snap-connected with the shell 100, and one end of the end functional component located inside the shell 100 is connected and matched with the roller seal component, and the bottom cover 200 is arranged outside the end functional component and is snap-connected with the shell 100, and is used to cooperate with the shell 100 to realize the protection of the end functional component

In an embodiment, the end functional component is a roller seal component, which is arranged inside one end of the shell 100 and is used to cooperate with the shell 100 to hide the logistics information.

The roller stamp assembly comprising:
Roller frame 301, the roller frame 301 is snap-fitted with the shell 100, one end of the roller frame 301 located in the shell 100 is provided with a first sleeve 302, one end of the cutting assembly is arranged in the first sleeve 302 to fix the cutting assembly;
Roller 303, the roller 303 is arranged in the roller frame 301, and one end of the roller 303 is rotatably connected to the roller frame 301; the roller limiter 304 is arranged in the roller frame One end of the roller limit plate 304 is rotatably connected to the roller frame 301, and the other end of the roller limit plate 304 is connected to the roller; the oil storage cotton core 305 is fixedly connected to the outside of the roller 303, that is, it is sleeved on the roller 303; the printing pad 306, the printing pad 306 is arranged on the outside of the oil storage cotton core 305, and the opening tool is pushed to drive the printing pad 306 to rotate, and then the ink on the printing pad 306 is covered on the logistics information, so as to hide the logistics information.

In another embodiment, the end functional component is a name stamp component, which is arranged inside one end of the shell 100.

The name stamp assembly comprising:

A mounting frame 401, the mounting frame 401 is snap-fitted with the shell 100, one end of the mounting frame 401 located in the shell 100 is provided with a second sleeve 402, one end of the cutting assembly is arranged in the first sleeve 302 to fix the cutting assembly, and the other end of the mounting frame 401 is provided with a mounting groove 403; a stamp 405, the stamp 405 is arranged in the mounting groove 403; for stamping, an inner plate 406, the inner plate 406 is provided with a circular hole 407, the circular hole 407 on the inner plate 406 is provided with a sleeve 408, the inner plate 406 is arranged in the outer Between the mounting frame 401 and the sliding assembly in the shell 100, the inner plate 406 is sleeved on the second sleeve 402 through the circular hole 407 and the sleeve 408, and can move up and down along the second sleeve 402. The four corners of the inner plate 406 are provided with support rods 404, and the other ends of the support rods 404 extend from the outer sides of the four corners of the mounting frame 401, and the height is higher than the seal 405. In this way, when stamping, the support rods 404 will be forced to retract into the shell 100, and then the seal 405 will be printed on the object. When not in use, the support rods 404 will extend out, and the height is higher than the seal 405, so as to protect the seal 405 to a certain extent.

The cutting assembly comprising:
A latch 501, which is disposed inside the shell 100, one end of which is connected to the end functional assembly, and a slot 502 is provided inside the other end of the latch 501;
A blade 503, which is disposed in the slot 502 and is connected and fixed by a pin and the latch 501;
A blade fixing buckle 504, which is disposed outside the slot 502 of the blade 503 and is engaged with the latch 501, and is used to cooperate with the latch 501 to fix the blade 503.

The sliding assembly comprising:
slider 601, which is disposed between the latch 501 and the shell 100 and can move up and down along the latch 501;
spring 602, which is sleeved on the latch 501, with the upper end of the spring 602 resting on the lower end of the slider 601, and the lower end of the spring 602 resting on one end of the end functional assembly;

After the top cover 101 is removed, the slider 601 is subjected to force, and the spring 602 inside will be compressed, and the slider 601 will be pressed in to a certain extent. The blade 503 will be exposed, and the whole unsealing tool can be slid while pressing to cut things. When the slider 601 is pressed down to expose the blade 503, the spring 602 is in a compressed state. When the slider 601 bounces up, the spring 602 is in an extended state. The hand presses hard against the surface of the carton or the object to be unsealed. At this time, the spring 602 is compressed, the blade 503 is exposed, and the package is opened. The hand is released, the spring 602 is extended, and the slider 601 slides out of the shell 100, hiding the blade 9 in the slider 601, which is more labor-saving, convenient and quick.

A top cover 101 is provided at the upper end of the outer shell 100 and is snap-connected to the outer shell 100. The top cover 101 is placed on the outside of the slider assembly to cooperate with the outer shell 100 to shield the cutting assembly. The slider 601 and the top cover 101 are both provided with a V-shaped opening 102 at one end away from the outer shell 100, and the upper end of the blade 503 is placed in the V-shaped opening 102.

When the device is in operation, the sliding assembly is disposed between the cutting assembly and the shell 100, and can slide up and down along the cutting assembly. Thus, when unsealing a carton, a document bag, or a courier package, the sliding assembly contacts the object and presses the shell. The sliding assembly is retracted into the inner side of the shell 100, and the cutting assembly extends to cooperate with the movement of the shell 100 to open the object.

The top cover 101 is placed outside the slider assembly, which can shield the cutting assembly to avoid accidental injury caused by the cutting assembly. Secondly, the slider 601 and the top cover 101 are both provided with a V-shaped opening 102 at one end away from the shell 100, and the upper end of the blade 503 is placed in the V-shaped opening 102. In this way, when opening envelopes and document bags, the envelopes and document bags can be directly inserted into the V-shaped opening 102. The V-shaped opening 102 of the top cover 101 will support the envelopes and document bags, limit the length of the blade 503 entering the envelopes and document bags, and prevent the blade 503 from cutting the documents, etc. Then, pull the opening tool to move, and the blade 503 will open the envelopes and documents along the edges of the envelopes and documents, which is more convenient.

By setting the top cover 101, the top cover 101 will only be removed when opening the carton or when a sharp tool is needed. In a normal state, the top cover 101 covers the outer shell 100 and will not press on the slider 601, thereby preventing accidental injury and providing higher safety.

In embodiment 1, as shown in FIGS. 1-4, is a combination of a roller stamp assembly and a cutting mechanism;

When in use, open an envelope or a document bag:

Make sure that the top cover 101 is installed on the shell 100, and place the seal of the envelope or document bag at the V-shaped opening 102; the V-shaped opening 102 of the top cover 101 will support the envelope and the document bag, limit the length of the blade 503 entering the envelope and the document bag, and prevent the blade 503 from cutting the document, etc.; then pull the opening tool to move, and the blade 503 will open the envelope and the document along the edges of the envelope and the document;

When opening a carton or other hard objects:

Remove the top cover 101; align the tool with the carton seal to ensure that the slider 601 is in contact with the carton; press down the shell 100, the slider 601 moves down along the latch 501 under pressure and compresses the spring 602, while the blade 503 extends out, pull the tool, and the blade 503 will cut the carton;

Release the shell 100, the spring 602 resets, the slider 601 rebounds and extends out of the shell 100, and the blade 503 is hidden in the slider 601.

When opening a courier package:
You need to squeeze the items in the courier package toward one end of the package to leave a space without courier items, and then remove the top cover 101; align the tool with the space without courier items in the package to ensure that the slider 601 is in contact with the package; press down the shell 100, the slider 601 moves down along the latch 501 under pressure and compresses the spring 602, while the blade 503 extends out, pull the tool, and the blade 503 will cut the package;
Release the shell 100, the spring 602 resets, the slider 601 rebounds and extends out of the shell 100, and the blade 503 is hidden in the slider 601.

Use of roller stamp assembly:
Installation: Connect the roller stamp assembly to the shell 100 through the roller frame 301, ensure that the roller 303, roller limiter 304, oil storage cotton core 305 and printing pad 306 are correctly installed, and ensure that there is ink in the oil storage cotton core 305;
Remove the bottom cover 200, roll the printing pad 306 on the logistics information to be hidden, complete the covering, and realize the hiding of the logistics information.

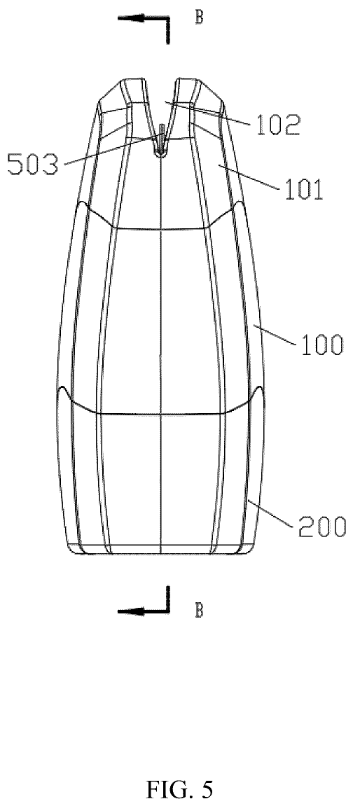

In embodiment 2, as shown in FIGS. 5-8, the name stamp assembly and the cutting mechanism are used in combination;

When in use, open the envelope or document bag:

Make sure that the top cover 101 is installed on the shell 100, and place the seal of the envelope or document bag at the V-shaped opening 102; the V-shaped opening 102 of the top cover 101 will support the envelope and document bag, limit the length of the blade 503 entering the envelope and document bag, and prevent the blade 503 from cutting the document, etc.; then pull the opening tool to move, and the blade 503 will open the envelope and document along the edge of the envelope and document;

When opening a carton or other hard objects:

Remove the top cover 101; align the tool with the carton seal to ensure that the slider 601 is in contact with the carton; press down the shell 100, the slider 601 moves down along the latch 501 under pressure and compresses the spring 602, while the blade 503 extends out, pull the tool, and the blade 503 will cut the carton;

Release the shell 100, the spring 602 resets, the slider 601 rebounds and extends out of the shell 100, and the blade 503 is hidden in the slider 601.

When opening a courier package:
You need to squeeze the items in the courier package toward one end of the package to leave a space without courier items, and then remove the top cover 101; align the tool with the space without courier items in the package to ensure that the slider 601 is in contact with the package; press down the shell 100, the slider 601 moves down along the latch 501 under pressure and compresses the spring 602, while the blade 503 extends, pull the tool, and the blade 503 will cut the package;
When the shell 100 is released, the spring 602 is reset, the slider 601 rebounds and extends out of the shell 100, and the blade 503 is hidden in the slider 601.

Installation: snap the name stamp assembly into the shell 100 through the mounting bracket 401;
Remove the bottom cover 200, dip the stamp 405 in a proper amount of ink, and then use it. When stamping, the support rod 404 will be retracted into the shell 100 under force, and then the stamp 405 will be printed on the object. When not in use, the support rod 404 will extend and the height will be higher than the stamp 405, so as to provide a certain degree of protection for the stamp 405.

1. A multifunctional opening tool, comprising a shell, a cutting mechanism; the cutting mechanism is arranged inside one end of the shell, and is used to open envelopes and cartons; wherein, the cutting mechanism includes:
a cutting assembly, the cutting assembly is fixed inside one end of the shell;
a sliding assembly, the sliding assembly is arranged between the cutting assembly and the shell, and can slide up and down along the cutting assembly, and is used to cooperate with the shell to protect the cutting assembly.

2. The multifunctional opening tool of claim 1, comprising an end functional component and a bottom cover, wherein the end functional component is arranged inside the other end of the shell and is snap-connected with the shell, one end of the end functional component located inside the shell is connected and matched with the roller stamp component, and the bottom cover is arranged outside the end functional component and is snap-connected with the shell to cooperate with the shell to realize protection of the end functional component.

3. The multifunctional opening tool of claim 2, wherein the end functional component is a roller seal component, which is arranged inside one end of the shell and is used to cooperate with the shell to hide the logistics information;
wherein the roller seal component, comprising a roller frame; the roller frame is clamped with the shell, and the end of the roller frame located in the shell is provided with a first sleeve, and one end of the cutting component is arranged in the first sleeve to fix the cutting component; the roller is arranged in the roller frame, and one end of the roller is rotatably connected to the roller frame; the roller limit plate is arranged in the roller frame, one end of the roller limit plate is rotatably connected to the roller frame, and the other end of the roller limit plate is connected to the roller;
wherein the oil storage cotton core is fixedly connected to the outside of the roller;
wherein the print pad is arranged on the outside of the oil storage cotton core, and is used to cooperate with the oil storage cotton core to hide the logistics information.

4. The multifunctional opening tool of claim 2, wherein the end functional component is a name stamp component, which is arranged inside one end of the shell;
wherein the name stamp component includes:
the mounting frame; the mounting frame is snap-connected with the shell, and the end of the mounting frame located inside the shell is provided with a second sleeve, one end of the cutting component is arranged in the first sleeve to fix the cutting component, and the other end of the mounting frame is provided with a mounting groove;
the seal; the seal is arranged in the mounting groove;
the inner plate; the inner plate is provided with a round hole, the inner plate is provided with a sleeve at the round hole, the inner plate is arranged between the mounting frame and the sliding component in the shell, the inner plate is sleeved on the second sleeve through the round hole and the sleeve, and can move up and down along the second sleeve, the inner plate is provided with support rods at the four corners, and the other end of the support rod extends from the outside of the four corners of the mounting frame, and the height is higher than the seal.

5. The multifunctional opening tool of claim 2, wherein the cutting assembly includes:
a latch, which is arranged inside the shell, one end of which is connected and matched with the end functional assembly, and a slot is arranged inside the other end of the latch;
a blade, which is arranged in the slot and fixed by connecting the pin and the latch;
a blade fixing buckle, which is arranged outside the slot of the blade and is connected with the latch to fix the blade in cooperation with the latch.

6. The multifunctional opening tool of claim 5, wherein the slider assembly includes:
a slider, which is arranged between the latch and the shell and can move up and down along the latch;
a spring, which is sleeved on the latch, the upper end of the spring abuts against the lower end of the slider, and the lower end of the spring abuts against one end of the end functional assembly.

7. The multifunctional opening tool of claim 5, wherein the upper end of the shell is provided with a top cover, which is clamped with the shell; wherein the top cover is placed outside the slider assembly to cooperate with the shell to cover the cutting assembly; wherein the slider and the top cover are both provided with a V-shaped opening at one end away from the shell; the upper end of the blade is placed in the V-shaped opening.
